(19) United States
(12) Patent Application Publication
(10) Pub. No.: US 2024/0163646 A1
(43) Pub. Date: May 16, 2024

(54) SYTEMS AND METHODS FOR PROVIDING LOCATION-BASED ANNOUNCEMENTS

(71) Applicant: Verizon Patent and Licensing Inc., Basking Ridge, NJ (US)

(72) Inventors: Kashif Khan, Keller, TX (US); Danysel Barthelme, Frisco, TX (US); Ronald E Collier, II, Arlington, TX (US); Ertao Li, Plano, TX (US); Steve L Padilla, Lewisville, TX (US); Gaurav Patel, McKinney, TX (US); Shawn R Pugh, Easton, PA (US); Shujaat Ali Siddique, Hillsborough, NJ (US); Daniel L Walker, Wall Township, NJ (US); John C Vinh Nguyen, Trophy Club, TX (US)

(21) Appl. No.: 17/984,367

(22) Filed: Nov. 10, 2022

(51) Int. Cl. H04W 4/12; H04W 4/02

(52) U.S. Cl. CPC H04W 4/12; H04W 4/025

(57) ABSTRACT

In an example, a request is received from a first user equipment (UE). The request corresponds to a request to establish a communication session with a second UE. A location of the first UE is determined based upon the request. An event datastore is analyzed, based upon the location of the first UE, to identify one or more events potentially impacting telecommunication services provided to the first UE. Based upon the one or more events, an announcement is provided for presentation on the first UE.

### BACKGROUND

Announcements (e.g., pre-recorded messages) may be provided to users making voice calls over a network (e.g., telephone). For example, an announcement may comprise promotional and/or informational messages provided to an originating number (e.g., a caller) of a voice call. The announcement can be a pre-call announcement (e.g., the announcement may be played before the voice/telephone call is established), a mid-call announcement (e.g., the announcement may be played during the established voice/telephone call), or a post-call announcement (e.g., the announcement may be played after the voice/telephone call is established and/or attempted to be established).

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating a system for providing location-based announcements, where a first user equipment (UE) displays a user interface comprising selectable inputs for accessing applications in accordance with an embodiment.

FIG. 1B is a diagram illustrating a system for providing location-based announcements, where a first UE displays a contact interface comprising a list of contacts in accordance with an embodiment.

FIG. 1C is a diagram illustrating a system for providing location-based announcements, where a first UE transmits a request to establish a communication session with a second UE in accordance with an embodiment.

FIG. 1D illustrates a first portion of content of a request to establish a communication session in accordance with an embodiment.

FIG. 1E illustrates a second portion of content of a request to establish a communication session in accordance with an embodiment.

FIG. 1F illustrates a first portion of content of a message transmitted by a first network element in accordance with an embodiment.

FIG. 1G illustrates a second portion of content of a message transmitted by a first network element in accordance with an embodiment.

FIG. 1H illustrates a data structure mapping a UE location of a first UE to locations of events indicated by an event datastore in accordance with an embodiment.

FIG. 1I is a diagram illustrating a system for providing location-based announcements, where an announcement is provided for presentation on a first UE in accordance with an embodiment.

FIG. 2 is a flow chart illustrating a method for providing location-based announcements in accordance with an embodiment.

FIG. 3 is a diagram illustrating a scenario associated with delivery of one or more announcements to a first UE in accordance with an embodiment.

FIG. 4 is an illustration of an example environment in which at least a portion of the techniques presented herein may be utilized and/or implemented.

FIG. 5 is an illustration of an example network that may utilize and/or implement at least a portion of the techniques presented herein.

FIG. 6 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for providing location-based announcements are provided. A network operator may play an announcement (e.g., a pre-recorded audio message) to a caller to inform the caller of a failure (and/or a potential failure) of a phone/voice call. In some systems, the announcement may be generic and may not define a reason for why the announcement is received. For example, the announcement (e.g., including speech such as “Your call cannot be completed at this time, please try your call again”) may not provide an indication of one or more events that may have contributed to the failure of the call, thereby keeping the caller uninformed about the occurrence of the one or more events.

In accordance with one or more of the techniques provided herein, a location-based announcement system is provided. The announcement system may receive, from a first user equipment (UE), a request to establish a communication session with a second UE. The communication session may be a voice call, a video call, a messaging session using a messaging interface, etc. In an example, the first UE may correspond to a caller and/or originator of a call (e.g., a voice call and/or a video call) and the second UE may correspond to a receiver and/or destination of the call. The announcement system may determine a first location of the first UE (e.g., a location of the caller/originator) and/or a second location of the second UE (e.g., a location of the receiver/destination). The announcement system may use the first location and/or the second location to determine an announcement, and may provide the announcement for presentation on the first UE. For example, the announcement may be a pre-call announcement (e.g., the announcement may be played before the communication session is established), a mid-call announcement (e.g., the announcement may be played during the established communication session), or a post-call announcement (e.g., the announcement may be played after the communication session is established and/or attempted to be established).

In some examples, the first location and/or the second location are used to identify one or more events (e.g., a natural event, an anthropogenic event, a maintenance event, an emergency situation, a network element failure, etc.) that may potentially impact the communication session of the first UE with the second UE. For example, the one or more events may negatively impact a quality of the communication session (e.g., resulting in sound and/or video of the communication session to break up, increased jitter, increased packet loss rate, increased round-trip time, etc.) and/or may even prevent the communication session from being established. The announcement may be indicative of an event of the one or more events. For example, when there is a weather event (e.g., a tornado) that is in the vicinity of the first UE and/or that potentially impacts telecommunication services provided to the first UE, the announcement may include speech such as “Your call cannot be completed at this time, which may be due to an ongoing weather event in your area, please try your call again”. In this way, the caller is informed of one or more events that caused the communication session to fail, and may take appropriate steps in light of the one or more events (e.g., the caller may try to contact a desired entity using a different mode of communication, and/or may seek shelter and/or take other safety measures in response to being informed of an emergency situation, etc.).

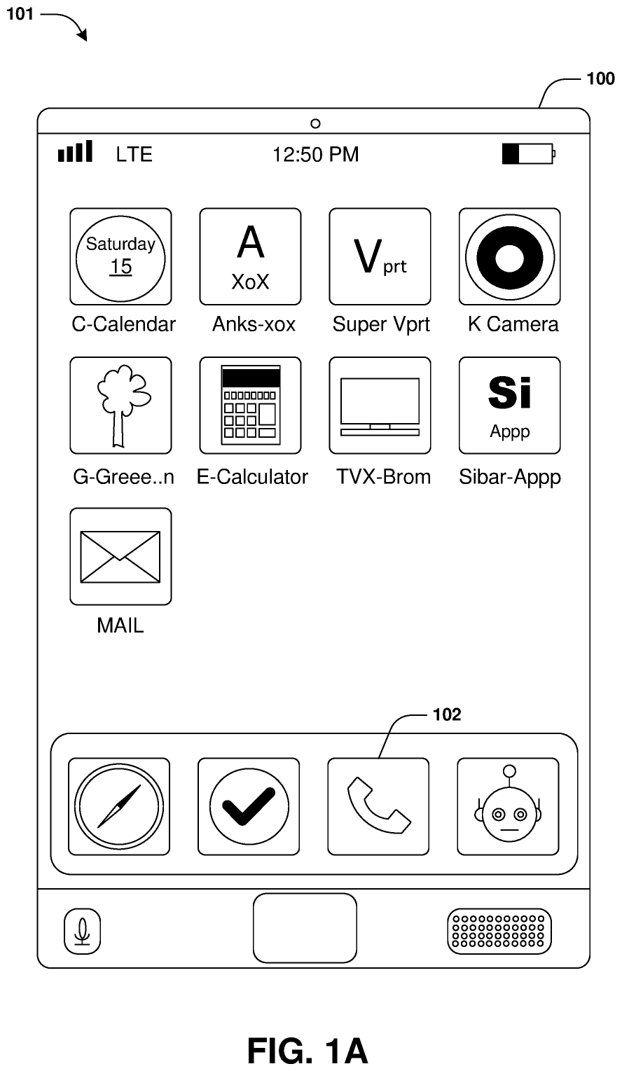

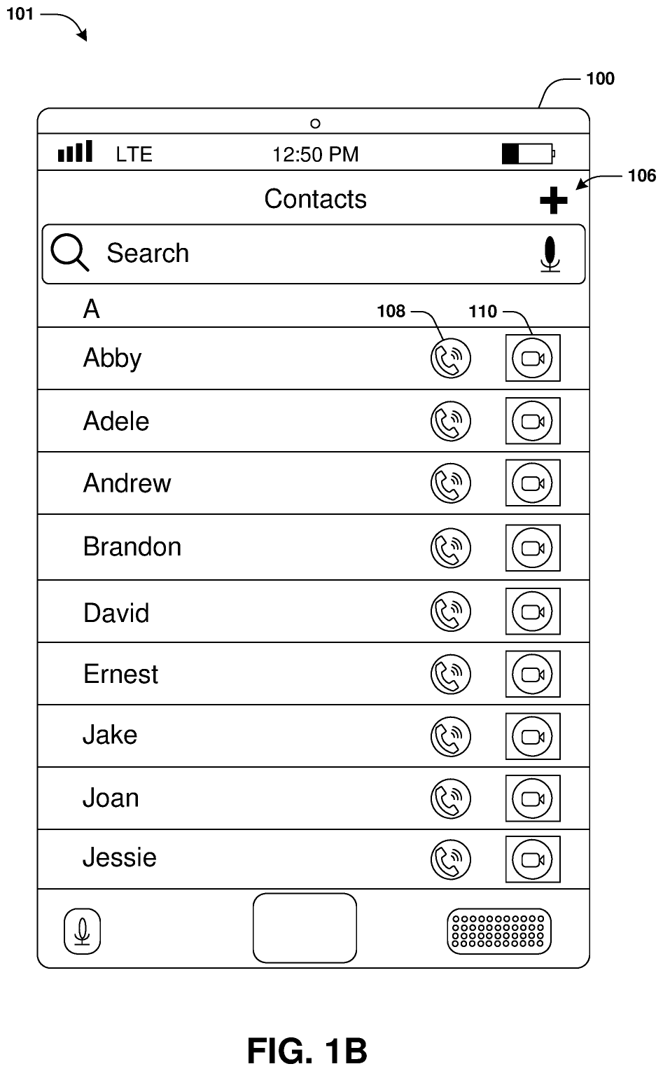

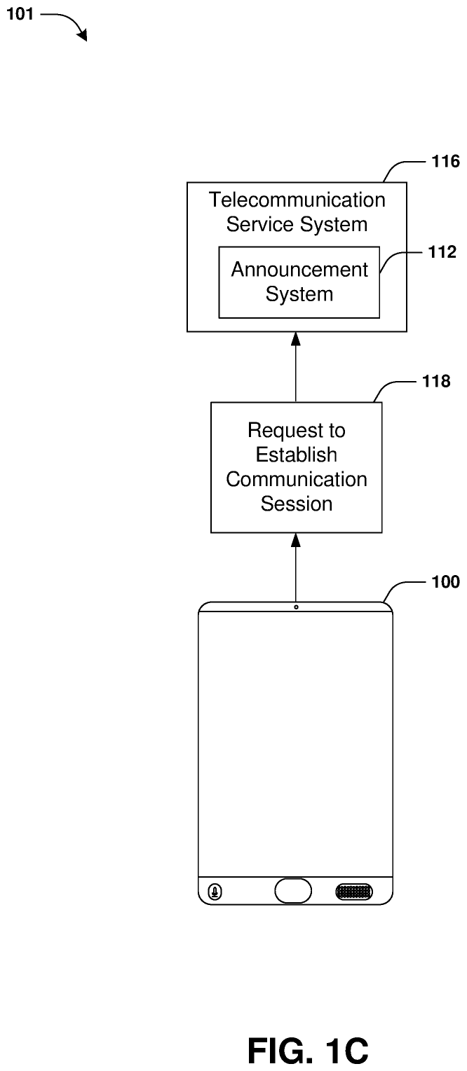

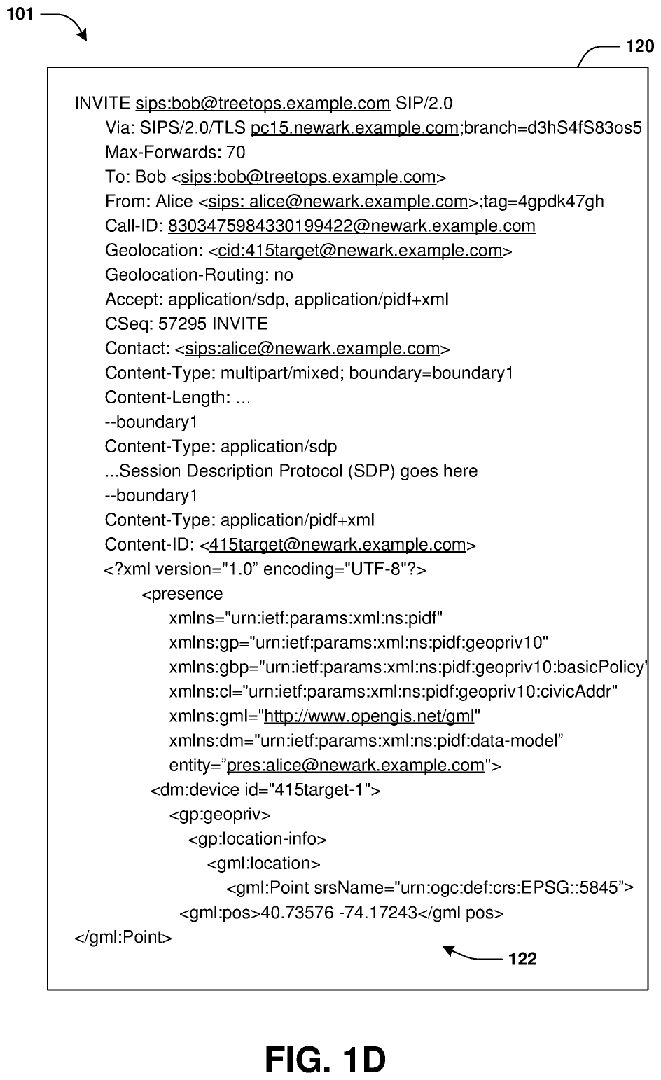

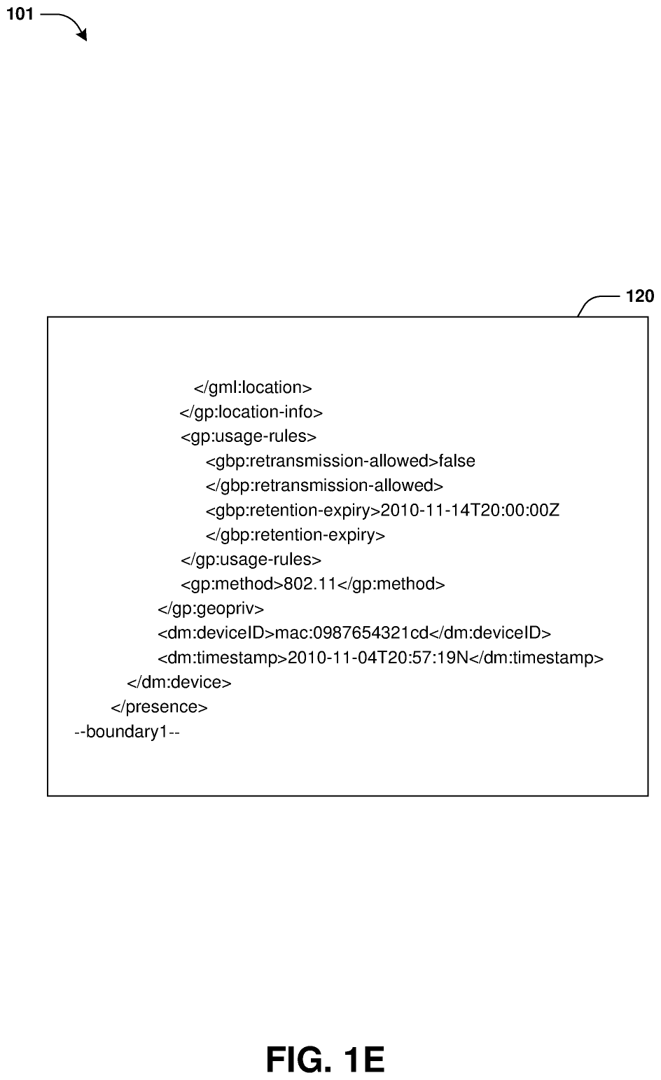

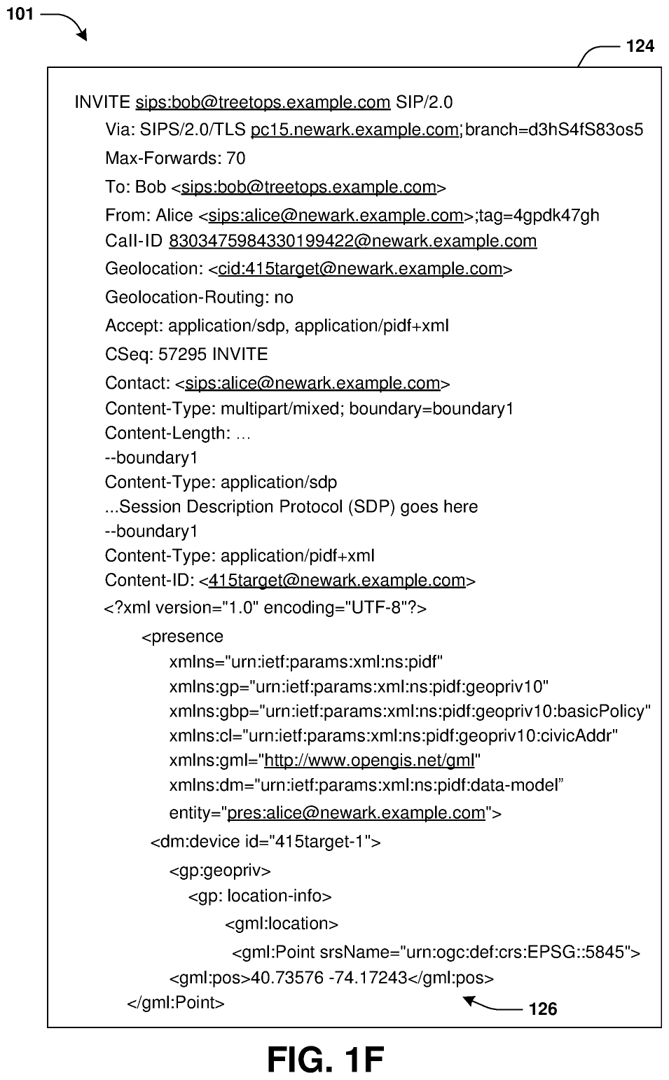

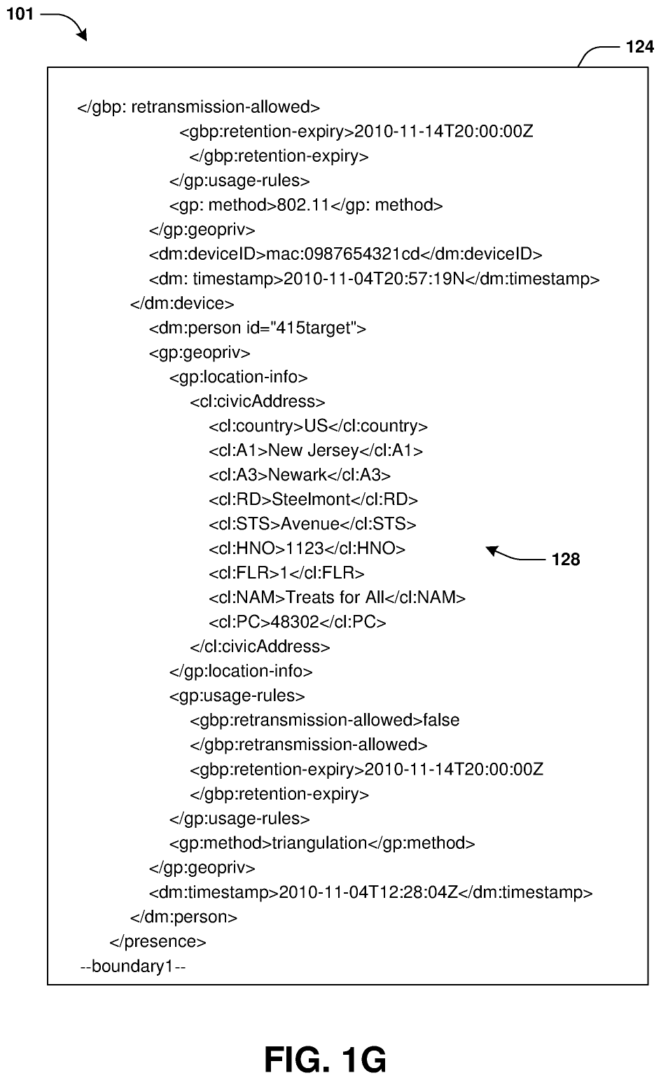

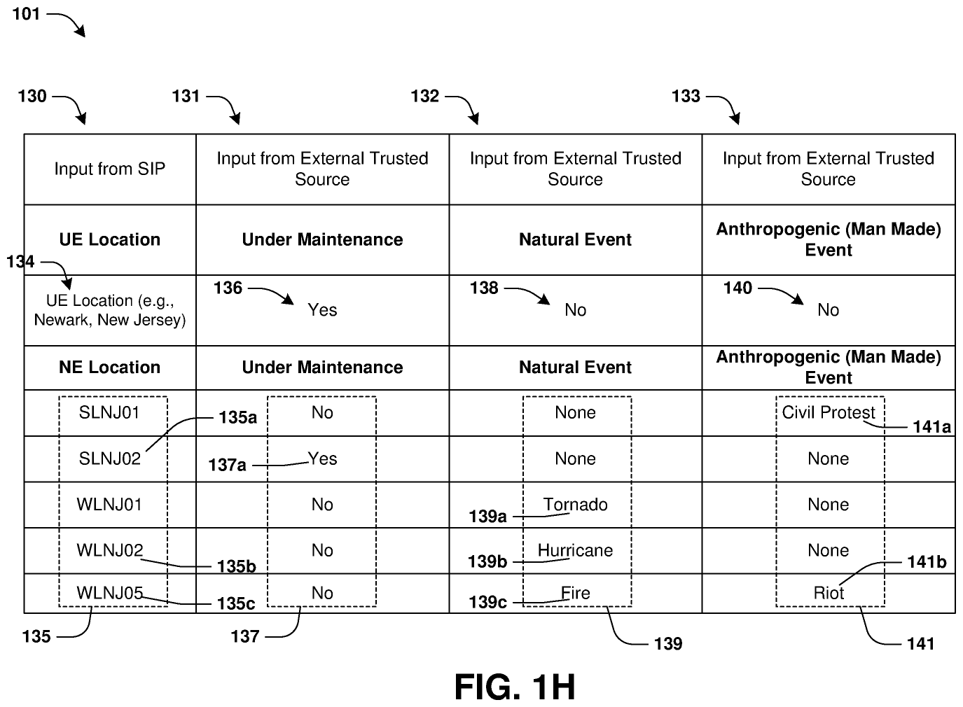

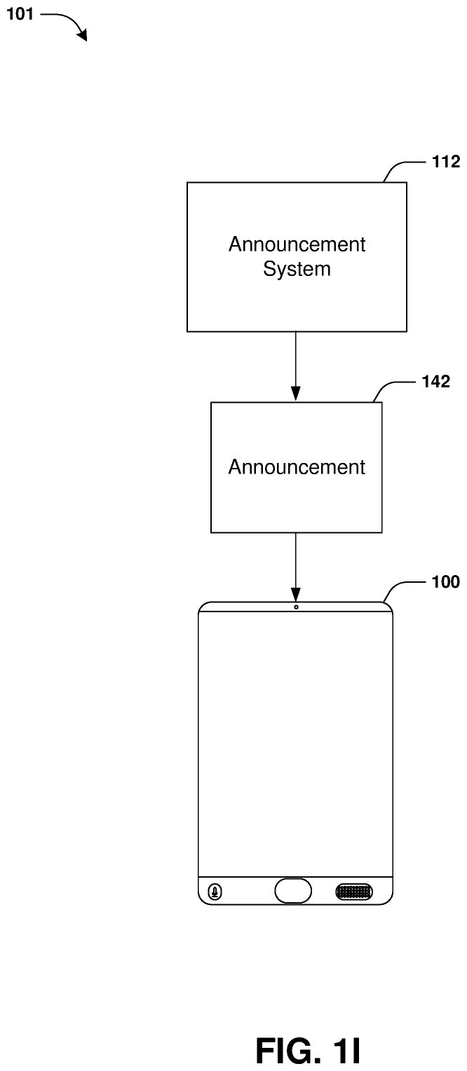

FIGS. 1A-1I illustrate examples of a system 101 for providing location-based announcements. FIGS. 1A-1C illustrates a first UE 100 being controlled (by a user) to request initiation of a communication session (e.g., a voice call, a video call, etc.). FIG. 1A illustrates the first UE 100 (e.g., a smart phone, a laptop computer, a tablet computer, a wearable device) displaying a user interface comprising selectable inputs for accessing applications (e.g., mobile applications installed on the first UE 100, web applications, etc.), functions, services, etc. The selectable inputs may comprise a communication selectable input 102 associated with opening a communication application that provides services for communicating with other users (e.g., by at least one of voice call, video call, messaging, etc.).

FIG. 1B illustrates a contact interface 106 of the communication application displayed by the first UE 100 in response to a selection of the communication selectable input 102. The contact interface 106 may display a list of contacts and/or selectable inputs (e.g., a voice call selectable input 108, a video call selectable input 110, etc.). In response to a selection of the voice call selectable input 108, the first UE 100 may transmit, to a telecommunication service system, a request to establish a voice call with a second UE associated with a second user “Abby”. In response to a selection of the video call selectable input 110, the first UE 100 may transmit, to the telecommunication service system, a request to establish a video call with the second UE.

FIG. 1C illustrates the first UE 100 transmitting, to the telecommunication service system (shown with reference number 116), a request 118 to establish a communication session (e.g., a voice call or a video call) with the second UE.

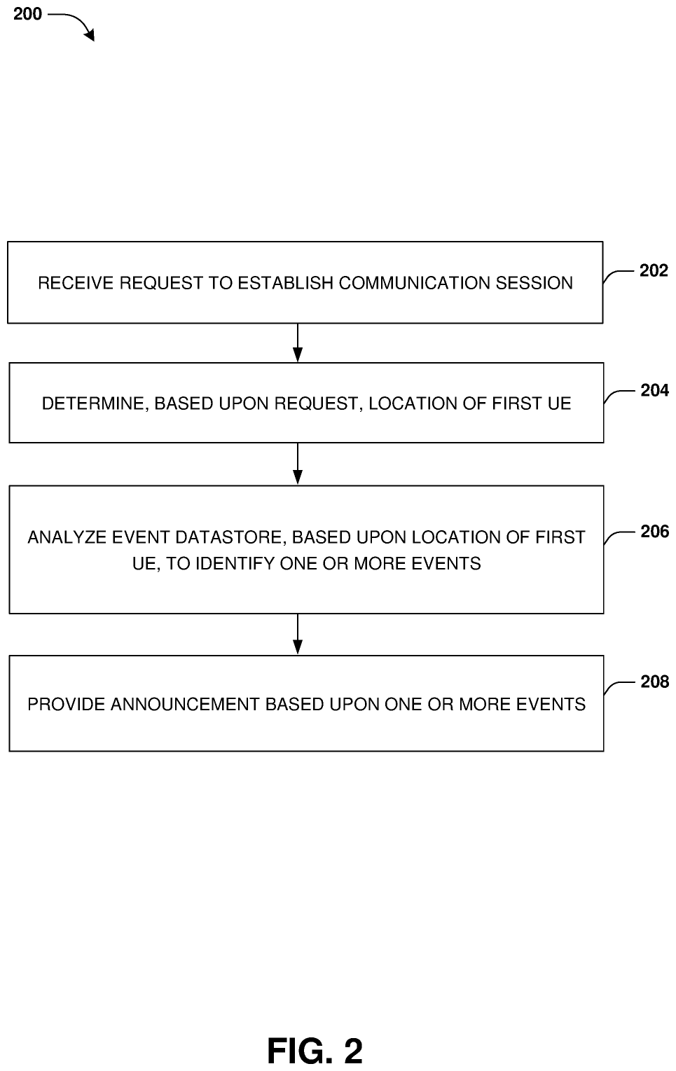

An embodiment of providing location-based announcements is illustrated by an example method 200 of FIG. 2, and is further described in conjunction with FIGS. 1A-1I. At 202, the request 118 to establish the communication session may be received (by the telecommunication service system 116, for example). In some examples, the user of the first UE 100 may be subscribed to a telecommunication service plan associated with wireless telecommunication services provided by the telecommunication service system 116. For example, the telecommunication service system 116 may provide wireless communication services for the first UE 100 and/or a first phone number (e.g., a Mobile Telephone Number (MTN)) of the first UE 100 in accordance with the telecommunication service plan.

The telecommunication service system 116 may comprise an announcement system 112 configured to provide announcements (e.g., location-based announcements) to callers utilizing telecommunication services of the telecommunication service system 116. The announcements may comprise pre-call announcements, mid-call announcements, and/or post-call announcements. In some examples, the announcement system 112 comprises a network operator, of the telecommunication service system 116, that receives the request 118 and/or is configured to provide one or more announcements to one or more UEs.

At 204, a UE location of the first UE 100 may be determined (by the announcement system 112, for example). For example, the UE location of the first UE 100 may be determined based upon the request 118.

In some examples, the announcement system 112 may utilize a location conveyance function associated with a signaling protocol that is used by the telecommunication service system 116 to initiate, establish, maintain and/or terminate communication sessions between UEs. In an example, the signaling protocol may be Session Initiation Protocol (SIP) and/or may be used in at least one of Internet telephony, Voice over Internet Protocol (VoIP), private Internet Protocol (IP) telephone systems, Voice over Wi-Fi (VoWifi), mobile phone calling, etc. provided by the telecommunication service system 116.

According to the location conveyance function of the signaling protocol, the request 118 (e.g., a SIP request, such as a SIP invite) may be generated (by the first UE 100, for example) to include location information associated with the UE location of the first UE 100. For example, the request 118 may comprise one or more geolocation fields indicative of the location information. In an example, the one or more geolocation fields may comprise a geolocation header field, a geolocation-routing header field (e.g., indicating whether permission is granted to use location information associated with the first UE 100 for making routing decisions for routing the request 118) and/or a geolocation-error field (e.g., comprising error information associated with one or more location errors).

In some examples, a geolocation field (e.g., the geolocation header field) in the request 118 may comprise a location object. The location object may be indicative of a geographical position of the first UE 100. For example, the geographical position may comprise a set of coordinates (e.g., a longitude coordinate and/or a latitude coordinate) corresponding to a geographical point of the first UE 100. Alternatively and/or additionally, the location object may comprise an indication of a geographical region (e.g., a city, a state, a zip code, etc.) and/or a physical address (e.g., a civic address) associated with the first UE 100. In an example, the location object may comprise a P-Access-Network-Info (P-ANI), such as a P-ANI SIP header. Accordingly, the announcement system 112 may determine the UE location of the first UE 100 by (i) analyzing the request 118 to identify the geolocation field in the request 118, and/or (ii) determining the UE location based upon the location object in the geolocation field (e.g., based upon the geographical position, the geographical region and/or the physical address indicated by the location object). In some examples, the UE location corresponds to a geographical region (e.g., a UE location radius, a city, a state, a zip code, etc.) comprising the geographical position. For example, the UE location may be indicative of a city and/or state (and/or a zip code) in which the first UE 100 is located.

Alternatively and/or additionally, the request 118 may comprise a reference (e.g., a location Uniform Resource Identifier (URI)) to the location object. For example, the reference may be included in the geolocation field (e.g., the geolocation header field) in the request 118. The reference may be indicative of a resource comprising the location object. For example, the resource may correspond to an attachment to the request 118 (e.g., a Multipurpose Internet Mail Extensions (MIME) body attached to the request 118). Alternatively and/or additionally, the resource may correspond to an external resource (e.g., a remote resource that is not attached to the request 118) that may be accessible over a network. In an example, the external resource may be stored on a location datastore (e.g., a location server) configured to store location objects associated with UEs. The resource may be accessed using the reference (e.g., the location URI). Accordingly, the announcement system 112 may determine the UE location of the first UE 100 by (i) analyzing the request 118 to identify the reference (e.g., in the geolocation field of the request 118), (ii) accessing, based upon the reference, the resource (e.g., the attachment or the external resource), (iii) retrieving the location object from the resource, and/or (iv) determining the UE location based upon the geographical position indicated by the location object.

An example of the geolocation field (e.g., the geolocation header field) in the request 118 (e.g., a SIP request) is shown using metalanguage formatted according to Augmented Backus-Naur Form (ABNF) (according to RFC 5234 “Augmented BNF for Syntax Specifications: ABNF”):

```
message-header =/ Geolocation-header
  ; (message-header from RFC 3261)
Geolocation-header = “Geolocation” HCOLON locationValue
  *( COMMA locationValue )
locationValue = LAQUOT locationURI RAQUOT
  *(SEMI geoloc-param)
locationURI = sip-URI / sips-URI / pres-URI
  / http-URI / https-URI
  / cid-url ; (from RFC 2392)
  / absoluteURI ; (from RFC 3261)
```

FIGS. 1D-1E illustrate an example of content 120 in the request 118. A first portion of the content 120 is shown in FIG. 1D and a second portion of the content 120 is shown in FIG. 1E. As shown in FIG. 1D, the request 118 may comprise an indication 122 (e.g., a Geography Markup Language (GML) position indication “gml:pos”) of the geographical position. For example, the indication 122 may comprise a latitude coordinate (e.g., 40.73576) and/or a longitude coordinate (e.g., −74.17243).

In some examples, the request 118 may be generated to convey the UE location of the first UE 100 in accordance with one or more standards and/or specifications (e.g., associated with SIP), which may include: (i) RFC 6442 “Location Conveyance for the Session Initiation Protocol”, (ii) RFC 3261 “SIP: Session Initiation Protocol”, (iii) RFC 3693 “Geopriv Requirements”, and/or (iv) RFC 2392 “Content-ID and Message-ID Uniform Resource Locators”. Further, the first UE 100, the telecommunication service system 116 and/or the second UE may communicate (e.g., with each other) according to one, some and/or all of the one or more standards and/or specifications.

In some examples, the request 118 may not comprise an indication of the UE location of the first UE 100, and/or the announcement system 112 may utilize one or more location datastores (e.g., one or more location servers) to look up stored location information of the first UE 100. The request 118 may be analyzed to identify a UE identifier, of the first UE 100, in the request 118. For example, the UE identifier may comprise at least one of the first phone number, a username of an account that the user of the first UE 100 has with the telecommunication service system 116, a Subscriber Identity Module (SIM) identifier (e.g., Integrated Circuit Card ID (ICCID)) of a SIM of the first UE 100, an International Mobile Equipment Identity (IMEI), etc. The announcement system 112 may analyze a location datastore (e.g., a location server) to identify location information associated with the UE identifier. For example, the location information may be determined to be associated with the first UE 100 based upon an indication, of the UE identifier, in the location information. In some examples, the location information was (previously) stored in the location datastore based upon information shared by the first UE 100 (and/or by the user of the first UE 100). For example, the information may have been shared (with the telecommunication service system 116) during service sign up of the first UE 100 (e.g., the information was used by the telecommunication service system 116 to activate telecommunication services for the first UE 100). The UE location of the first UE 100 may be determined based upon the location information in the location datastore. In some examples, the location information may comprise a set of coordinates (e.g., a longitude coordinate and/or a latitude coordinate) corresponding to a geographical point of the first UE 100. Alternatively and/or additionally, the location information may comprise an indication of a geographical region (e.g., a city, a state, a zip code, etc.) and/or a physical address (e.g., a civic address) associated with the first UE 100. In an example, the location information may comprise a P-ANI, such as a P-ANI SIP header.

At 206, the announcement system 112 may analyze an event datastore to identify one or more events potentially impacting the communication session (e.g., requested by the first UE 100) and/or telecommunication services provided to the first UE 100. The one or more events may comprise at least one of a natural event (e.g., a weather event), an anthropogenic event (e.g., a man-made event), a maintenance event (e.g., maintenance being performed on one or more network elements), an emergency situation, a network element failure event (e.g., a network element not functioning properly), etc. For example, the one or more events may be determined to have a potential impact (e.g., negative impact) on a quality of the communication session (e.g., resulting in sound and/or video of the communication session to break up, increased jitter, increased packet loss rate, increased round-trip time, etc.). For example, it may be determined that there is a likelihood (e.g., a likelihood exceeding a threshold likelihood) that the one or more events could potentially prevent the communication session from being established and/or cause the communication session to fail.

The one or more events may be determined based upon the UE location of the first UE 100. For example, the UE location may be used (in conjunction with one or more event locations of the one or more events, for example) to determine that the one or more events may potentially have an impact on telecommunication services provided to the first UE 100. The event datastore may be indicative of a plurality of events and/or event locations associated with the plurality of events (e.g., an event location may be stored in the event datastore in association with an event). The UE location of the first UE 100 may be compared with the event locations to identify the one or more events. For example, the one or more events may be identified in response to determining that one or more event locations correspond to the UE location of the first UE 100. For example, a first event (of the one or more events) may be identified as potentially having an impact on the communication session and/or telecommunication services provided to the first UE 100 based upon a determination that an event location of the first event corresponds to the UE location of the first UE 100. The determination that the event location of the first event corresponds to the UE location may comprise a determination that the event location matches (e.g., is within and/or at) the UE location and/or is within a threshold distance of the UE location.

In some examples, the plurality of events may comprise a plurality of network element events (e.g., maintenance events and/or failure events) associated with network elements (e.g., network elements used by the telecommunication service system 116 to provide telecommunication services). A network element event may be associated with maintenance of a network element. For example, the network element event may correspond to a period in which the network element is undergoing (and/or is scheduled to undergo) maintenance, such as (i) physical maintenance in which hardware of the network element is replaced, repaired and/or serviced, and/or (ii) software and/or firmware maintenance in which software and/or firmware are at least one of updated, replaced, etc. Alternatively and/or additionally, a network element event may be associated with a failure of a network element, such as when the network element at least one of does not function correctly, is not powered on, etc. Event locations associated with the plurality of network element events may be stored in in the event datastore. An event location associated with a network element event may be a network element location of a network element associated with the network element.

In some examples, a first network element event may be associated with a first network element. A first network element location associated with the first network element (e.g., an event location of the first network element event) may be stored in the event datastore in association with the first network element event. The first network element may be determined based upon a message transmitted by the first network element. In some examples, the message may be generated according to the signaling protocol (e.g., based upon the location conveyance function of the signaling protocol).

The message transmitted by the first network element may include a geolocation field (e.g., a geolocation header field) that may be used to determine the first network element location. For example, the geolocation field in the message may comprise a location object. The location object may be indicative of a geographical position of the first network element. For example, the geographical position may comprise a set of coordinates (e.g., a longitude coordinate and/or a latitude coordinate) corresponding to a geographical point of the first network element. Alternatively and/or additionally, the location object may comprise an indication of a geographical region (e.g., a city, a state, a zip code, etc.) and/or a physical address (e.g., a civic address) associated with the first network element. In an example, the location object may comprise a P-ANI, such as a P-ANI SIP header. Accordingly, the announcement system 112 may determine the first network element location of the first network element by (i) analyzing the message transmitted by the first network element to identify the geolocation field in the message, and/or (ii) determining the first network element location based upon the location object in the geolocation field (e.g., based upon the geographical position, the geographical region and/or the physical address indicated by the location object). In some examples, the first network element location corresponds to a geographical region (e.g., a network element location radius, a city, a state, a zip code, etc.) comprising the geographical position. For example, the first network element location may be indicative of a city and/or state (and/or a zip code) in which the first network element is located.

Alternatively and/or additionally, the message transmitted by the first network element may comprise a reference (e.g., a location URI) to the location object. For example, the reference may be included in the geolocation field (e.g., the geolocation header field) in the message. The reference may be indicative of a resource (e.g., an attachment to the message, a MIME body attached to the message, an external resource that may be accessible over a network, etc.) comprising the location object. The resource may be accessed using the reference (e.g., the location URI). Accordingly, the announcement system 112 may determine the first network element location of the first network element by (i) analyzing the message to identify the reference (e.g., in the geolocation field of the message), (ii) accessing, based upon the reference, the resource (e.g., the attachment or the external resource), (iii) retrieving the location object from the resource, and/or (iv) determining the first network element location based upon the location object.

FIGS. 1F-1G illustrate an example of content 124 in the message transmitted by the first network element. A first portion of the content 124 is shown in FIG. 1F and a second portion of the content 124 is shown in FIG. 1G. As shown in FIG. 1F, the message may comprise an indication 126 (e.g., a GML position indication “gml:pos”) of the geographical position. For example, the indication 126 may comprise a latitude coordinate (e.g., 40.73576) and/or a longitude coordinate (e.g., −74.17243). Alternatively and/or additionally, as shown in FIG. 1G, the message may comprise an indication 128 of a physical address (e.g., a civic address comprising “1123 Steelmont Avenue, Newark New Jersey, US”).

In some examples, the first network element event may be determined based upon a message received from the first network element event (e.g., the message may be indicative of scheduled maintenance for the first network element and/or failure of the first network element). Alternatively and/or additionally, the first network element event may be determined based upon a message received from a network element management device. In some examples, when the first network element event is a maintenance event associated with maintenance scheduled for the first network element, the network element management device may (i) determine a time at which the maintenance is scheduled for the first network element, and/or (ii) notify the announcement system 112 of the time and/or the first network element associated with the first network element, thereby enabling the announcement system 112 to determine when the first network element is scheduled to undergo maintenance (e.g., the announcement system 112 may be able to determine when telecommunication services performed using the first network element can be potentially impacted by maintenance on the first network element). Alternatively and/or additionally, when the first network element event is a failure event associated with a failure of the first network element (e.g., the first network element at least one of not functioning correctly, not being powered on, etc.), the network element management device may (i) identify the failure of the first network element, and/or (ii) notify the announcement system 112 of the failure of the first network element. In some examples, in response to identifying the first network element event and/or determining the first network element location associated with the first network element, an indication of the first network element event and/or the first network element location may be stored in the event datastore.

One or more of the techniques provided herein with respect to identifying the first network element event, determining the first network element location associated with the first network element, and/or updating the event datastore to include an indication of the first network element event and/or the first network element location may be used to identify other network element events, determine other network element locations, and/or update the event datastore to include indications of the other network element events and/or the other network element locations.

In some examples, the announcement system 112 may determine information (e.g., location, time, event type, etc.) associated with at least some events (e.g., natural events, anthropogenic events, emergency situations, etc.) of the plurality of events using one or more resources (e.g., trusted external resources) and/or may store the information in the event datastore. In some examples, the one or more resources may comprise one or more natural event data systems (e.g., one or more weather systems) and/or one or more emergency data systems. The announcement system 112 may transmit a request for event information to a resource (e.g., a natural event data system, an emergency data system, etc.) of the one or more resources. In response to the request for the event information, the resource may provide the announcement system 112 with the event information indicative of at least one of a location of an event (e.g., a natural event, an anthropogenic event, an emergency situation, etc.), a time of the event (e.g., a time at which the event started and/or whether the event is still continuing), and/or an event type of the event (e.g., power outage, natural disaster, tornado, hurricane, thunderstorm, heavy rain, fire, protesting, riot, etc.). In response to receiving the event information, the announcement system 112 may store an indication of the location, the time, and/or the event type in the event datastore. In some examples, the announcement system 112 may request (e.g., in a periodic or aperiodic manner) event information from the resource and/or update the event datastore based upon information received from the one or more resources. Alternatively and/or additionally, the resource may provide the announcement system 112 with event information of an event in response to (e.g., immediately upon) detecting the event (even without having received a request for the event information from the announcement system 112, for example).

FIG. 1H illustrates a data structure 129 mapping the UE location of the first UE 100 to locations of events indicated by the event datastore. In some examples, the data structure 129 may be stored in the event datastore and/or may be used to identify the one or more events potentially impacting the communication session (e.g., requested by the first UE 100) and/or telecommunication services provided to the first UE 100. A column 130 of the data structure 129 may comprise entries indicative of locations comprising the UE location (shown with reference number 134) and/or network element locations 135 of network elements. The locations may be determined based upon messages (e.g., the request 118 and/or messages transmitted by network elements) generated according to the signaling protocol (e.g., SIP).

A column 131 of the data structure 129 may comprise entries associated with maintenance information, comprising (i) a first indication 136 “Yes” that telecommunication services provided to the first UE 100 may be potentially impacted by a maintenance event and/or (ii) indications 137 of whether or not network elements associated with the network element locations 135 are undergoing maintenance. For example, it may be determined that telecommunication services provided to the first UE 100 may be potentially impacted by a maintenance event based upon (i) an indication 137a that a network element associated with a network element location 135a is undergoing maintenance (e.g., the network element location 135a may comprise “SLNJ02”, which may be indicative of a region “South Lake, New Jersey” in which the network element is located) and/or (ii) a determination that the UE location 134 of the first UE 100 is within a threshold distance of the network element location 135a. The maintenance information indicated by entries in the column 131 may be determined based upon information received from the one or more resources (e.g., external trusted resources).

A column 132 of the data structure 129 may comprise entries associated with natural event information, comprising (i) a first indication 138 “No” that telecommunication services provided to the first UE 100 may not be potentially impacted by a natural event and/or (ii) indications 139 of natural events that may potentially impact activity of network elements associated with the network element locations 135. For example, it may be determined that telecommunication services provided to the first UE 100 may not be potentially impacted by a natural event based upon a determination that natural event locations associated with natural events (e.g., tornado, hurricane and/or fire) indicated by indications 139a-139c are not within a threshold distance of the UE location 134 of the first UE 100. In some examples, the natural event locations may correspond to network element locations of network elements that are potentially impacted by the natural events. For example, a natural event location of a hurricane (corresponding to indication 139b) may correspond to a network element location 135b of a network element that may be potentially impacted by the hurricane. Alternatively and/or additionally, the natural event locations may be determined separately from the network element locations 135. The natural event information indicated by entries in the column 132 may be determined based upon information received from the one or more resources (e.g., external trusted resources).

A column 133 of the data structure 129 may comprise entries associated with anthropogenic event information, comprising (i) a first indication 140 “No” that telecommunication services provided to the first UE 100 may not be potentially impacted by an anthropogenic event and/or (ii) indications 141 of anthropogenic events that may potentially impact activity of network elements associated with the network element locations 135. For example, it may be determined that telecommunication services provided to the first UE 100 may not be potentially impacted by an anthropogenic event based upon a determination that anthropogenic event locations associated with anthropogenic events (e.g., civil protest, riot, etc.) indicated by indications 141a-141b are not within a threshold distance of the UE location 134 of the first UE 100. In some examples, the anthropogenic event locations may correspond to network element locations of network elements that are potentially impacted by the anthropogenic events. For example, an anthropogenic event location of a riot (corresponding to indication 141b) may correspond to a network element location 135c of a network element that may be potentially impacted by the riot. Alternatively and/or additionally, the anthropogenic event locations may be determined separately from the network element locations 135. The anthropogenic event information indicated by entries in the column 133 may be determined based upon information received from the one or more resources (e.g., external trusted resources).

At 208, an announcement may be provided for presentation on the first UE 100. For example, the announcement may be based upon the one or more events (determined to have a potential impact on telecommunication services provided to the first UE 100). For example, the announcement may be indicative of the one or more events (e.g., by indicating one or more event types of the one or more events). In an example, the announcement may comprise audio comprising speech representative of the one or more events. The audio may be transmitted to the first UE 100, which may play the audio (e.g., using speakers) to the user of the first UE 100. FIG. 1I illustrates the announcement system 112 transmitting the announcement (shown with reference number 142) to the first UE 100.

In an example, the announcement 142 may be a pre-call announcement. For example, the audio may be provided to the first UE 100 (and/or the audio may be played by the first UE 100) before performing (by the telecommunication service system 116, for example) an attempt to establish the communication session (e.g., the voice call and/or the video call).

In an example, the announcement 142 may be a mid-call announcement. For example, the audio may be provided to the first UE 100 (and/or the audio may be played by the first UE 100) after the communication session is established and/or before the communication session ends. For example, the audio may be provided to the first UE 100 during the communication session (and/or the audio may be played by the first UE 100 during the communication session) in response to a determination that a quality of the communication session does not meet a threshold quality (e.g., the quality of the communication session may be monitored and/or compared with the threshold quality).

In an example, the announcement 142 may be a post-call announcement. For example, the audio may be provided to the first UE 100 (and/or the audio may be played by the first UE 100) after performing the attempt to establish the communication session (e.g., the voice call and/or the video call). In some examples, the audio may be provided to the first UE 100 in response to a determination that the attempt to establish the communication session is unsuccessful. For example, the announcement 142 may inform the user of the first user as to why the attempt to establish the communication session was unsuccessful.

Alternatively and/or additionally, the audio may be provided to the first UE 100 (and/or the audio may be played by the first UE 100) after the communication session (e.g., the voice call and/or the video call) is established. For example, the audio may be provided to the first UE 100 in response to a determination that the communication session failed (e.g., ended abruptly) and/or a connection between the first UE 100 and the second UE disconnected (without receiving a request to end the communication session). For example, the announcement 142 may inform the user of the first user as to why the communication session failed and/or why the connection was disconnected.

In some examples, the attempt to establish the communication session may comprise transmitting a communication session initiation message to the second UE (indicated by the request 118). The communication session initiation message may comprise the request 118. For example, the telecommunication service system 116 may forward the request 118 to the second UE. In some examples, if the attempt is successful (e.g., the telecommunication service system 116 and/or the second UE successfully receives the communication session initiation message), the second UE may transmit a response signal to the telecommunication service system 116 and/or the first UE 100. In some examples, the communication session may be established in response to the response signal. During the (established) communication session, media packets (e.g., comprising audio and/or video of the communication session) may be exchanged between the first UE 100 and the second UE. In some examples, if the attempt is unsuccessful (e.g., the telecommunication service system 116 and/or the second UE do not receive the communication session initiation message), the communication session between the first UE 100 and the second UE may not be established.

In some examples, the announcement 142 may be selected from an announcement datastore comprising a plurality of announcements. In some examples, the plurality of announcements may be associated with a plurality of event types (e.g., power outage, natural disaster, tornado, hurricane, thunderstorm, heavy rain, fire, protesting, riot, etc.). For example, a first announcement in the announcement datastore may comprise audio comprising speech representative of a power outage (e.g., the first announcement may include speech such as “Your call cannot be completed due to a power outage in your area, please try your call again”), a second announcement in the announcement datastore may comprise audio comprising speech representative of a hurricane (e.g., the second announcement may include speech such as “Your call cannot be completed due to a hurricane in your area, please try your call again”), etc. The announcement datastore may be analyzed to identify the announcement 142 based upon a determination that an event type associated with the announcement 142 matches an event of the one or more events associated with the UE location 134 of the first UE 100.

In some examples, the announcement 142 may be generated by the announcement system 112 by synthesizing audio that comprises speech representative of an event of the one or more events. For example, a message indicative of an event of the one or more events may be generated, and the message may be used to generate the announcement 142. In an example in which the event is a tornado, the message may comprise the following text: “Your call cannot be completed due to a tornado in your area, please try your call again”. Alternatively and/or additionally, the message may be generated to include an indication of an event location of an event of the one or more events. For example, the message may comprise the following text: “Your call cannot be completed due to a tornado in Wilmington, please try your call again”. In this way, the user may know to be aware of the event location (e.g., and may take precautionary measures by avoiding the event location). In some examples, if the event is associated with a danger to human life, the message may be generated to include instructions indicating one or more safety measures that the user can take. For example, the message may comprise the following text: “Your call cannot be completed due to a tornado in your area, please seek shelter in a sturdy building, and stay in a small, protected space away from windows”. In this way, the user is notified of which safety measures to take. In some examples, audio comprising speech representative of the message may be synthesized by the announcement system 112 (e.g., the audio may be automatically synthesized, such as using one or more automatic speech synthesis techniques for producing human speech). The announcement 142 comprising the synthesized audio may be transmitted to the first UE 100.

Embodiments are contemplated in which the announcement 142 comprises text, indicative of the one or more events, that is transmitted to the first UE 100 (e.g., via a text message, an instant message, a push notification, an email, etc.) and/or displayed on a screen of the first UE 100.

Embodiments are contemplated in which the announcement 142 is determined based upon a second UE location of the second UE. The second UE location may be determined in response to the request 118. The telecommunication service system 116 may transmit a first message (e.g., the communication session initiation message or other message) to the second UE in response to the request 118. In response to the first message, the second UE may transmit (to the telecommunication service system 116, for example) a second message (e.g., the response signal or other message), which may be used to determine the second UE location. The second UE location of the second UE may be determined (based upon the request 118 and/or the second message, for example) using one or more of the techniques provided herein with respect to determining the UE location of the first UE 100.

In some examples, the second UE location may be determined based upon the second message. For example, the second UE location may be determined based upon a second location object included in the second message (e.g., the second location object, which may be included in a second geolocation field of the second message, may be indicative of a geographical position of the second UE). One or more of the features and/or characteristics of the location object associated with the first UE 100 may be applicable to the second location object. Alternatively and/or additionally, the second UE location may be determined based upon a reference (e.g., a location URI), in the second message, to the second location object (e.g., the reference may indicate a resource, such as at least one of an attachment to the second message, an external resource accessible over a network, etc., that comprises the second location object).

Alternatively and/or additionally, the location may be determined based upon a second UE identifier of the second UE. The second UE identifier (e.g., at least one of a second phone number of the second UE, a username of an account that a user of the second UE has with the telecommunication service system 116, a SIM identifier of a SIM of the second UE, an IMEI, etc.) may be determined based upon the request 118 and/or the second message (e.g., the request 118 and/or the second message may comprise an indication of the second UE identifier). In some examples, a location datastore (e.g., a location server) may be analyzed to identify location information associated with the second UE identifier, wherein the location information may be used to determine the second UE location of the second UE.

In some examples, the one or more events may be determined based upon the second UE location of the second UE, such as using one or more of the techniques provided herein with respect to determining the one or more events based upon the UE location of the first UE 100. For example, the one or more events may comprise at least one of one or more natural events, one or more anthropogenic events, one or more network element events (e.g., maintenance events and/or failure events), etc. that are determined to potentially have an impact on telecommunication services provided to the second UE (and thus may prevent the communication session requested by the request 118 from being successfully established). For example, the one or more events may be determined by comparing the second UE location with event locations of events indicated in the event datastore. The one or more events may be identified in response to determining that one or more event locations correspond to the second UE location of the second UE. The determination that an event location of an event corresponds to the second UE location may comprise a determination that the event location matches (e.g., is within and/or at) the second UE location and/or is within a threshold distance of the second UE location.

In an example in which the one or more events comprise an event associated with an event location that corresponds to the second UE location of the second UE, the announcement 142 may comprise an indication of the event, an indication of the second UE (e.g., the receiver of the call), and/or an indication of the event location of the event. In an example in which the event is a tornado, the announcement may comprise: “Your call cannot be completed due to a tornado in the receiver's area, please try your call again”.

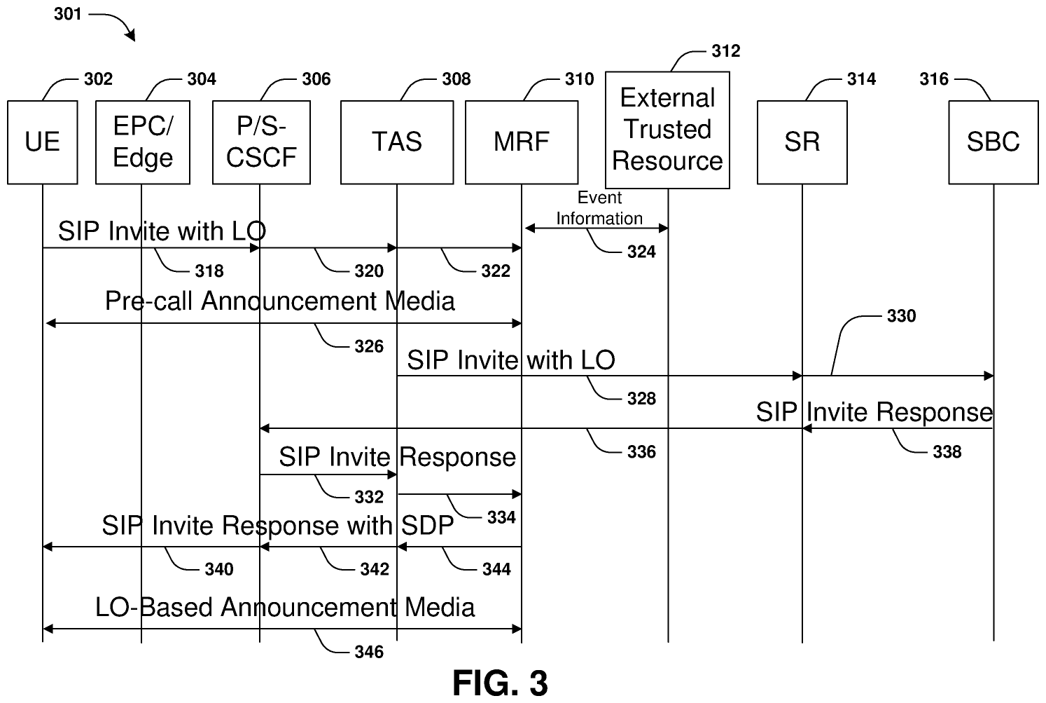

FIG. 3 illustrates a scenario associated with delivery of one or more announcements to a first UE 302 in a system 301. A multimedia resource function (MRF) 310 may communicate 324 (over Hypertext Transfer Protocol (HTTP) and/or other protocol) with one or more resources 312 (e.g., external trusted resources) to retrieve event information, which may be used to update the event datastore. The first UE 302 may transmit 318 a request to a Call Session Control Function (CSCF) 306 (comprising a Proxy CSCF (P-CSCF) and/or a Serving CSCF (S-CSCF), for example), which may forward 320 the request to a Telephony Application Server (TAS) 308, which may then forward 322 the request to the MRF 310. The request may comprise a SIP invite with a location object (LO) indicative of a UE location of the first UE 302. In some examples, the MRF 310 may be configured to perform one or more functions comprising at least one of processing media streams, coordinate and/or distribute voice traffic, play announcements to a user of the first UE 302, etc. The MRF 310 may provide 326 a pre-call announcement to the first UE 302, and the first UE 302 may play the pre-call announcement to the user. In some examples, the pre-call announcement may be determined based upon the UE location of the first UE 302 (e.g., using one or more of the techniques provided herein with respect to FIGS. 1A-1I and/or FIG. 2). For example, the pre-call announcement may be indicative of one or more events that may have a potential impact on telecommunication services provided to the first UE 302. In some examples, the pre-call announcement may be triggered by the TAS 308 (e.g., the TAS 308 may trigger the pre-call announcement based upon call origination, such as the first UE 302 and/or the UE location of the first UE 302).

In some examples, the TAS 308 may transmit 328 the request (e.g., the SIP invite indicative of the UE location of the first UE 302) to a Session Router 314, which may forward 330 the request to a Session Border Controller (SBC) 316, which may be configured to initiate, conduct and/or terminate communication sessions between UEs and/or manage security, connectivity, quality of service (QoS), etc. associated with the communication sessions. In some examples, the SBC 316 may transmit the request (and/or a message generated based upon the request) to the second UE, which may respond by transmitting a response message (e.g., a SIP Invite Response with a location object (LO) indicative of a location of the second UE) to the SBC 316. The SBC 316 may transmit 338 the response message to the SR 314, which may forward 336 the response message to the CSCF 306, which may forward 332 the response message to the TAS 308, which may then forward 334 the response message to the MRF 310.

In some examples, based upon the response message, the MRF 310 may generate a second response message comprising supplemental information (e.g., a SIP Invite Response with Session Description Protocol (SDP)), and may transmit 344 the second response message to the TAS 308, which may forward 342 the second response message to the CSCF 306, which may then forward 340 the second response message to the first UE 302. The supplemental information may comprise a name and/or purpose of the communication session, media to be exchanged in the communication session, one or more protocols and/or codec formats to be used in the communication session, and/or other information associated with the communication session. In some examples, if the communication session is successfully established, media packets comprising audio and/or video of the communication session may be exchanged between the first UE 302 and the second UE after the second response message is delivered to the first UE 302. Alternatively and/or additionally, if the communication session is not successfully established, media packets comprising audio and/or video of the communication session may not be exchanged between the first UE 302 and the second UE after the second response message is delivered to the first UE 302.

In some examples, the MRF 310 may provide 346 an announcement (e.g., a location-based announcement, such as a mid-call announcement and/or a post-call announcement) to the first UE 302, and the first UE 302 may play the announcement to the user. In some examples, the announcement may be determined based upon the UE location of the first UE 302 (e.g., using one or more of the techniques provided herein with respect to FIGS. 1A-1I and/or FIG. 2). For example, the announcement may be indicative of one or more events that may have a potential impact on telecommunication services provided to the first UE 302.

It may be appreciated that although examples herein are provided with respect to communication sessions comprising voice calls and/or video calls, at least some of the techniques provided herein for providing announcements in association with communication sessions that comprise messaging sessions (e.g., that are performed using a messaging interface).

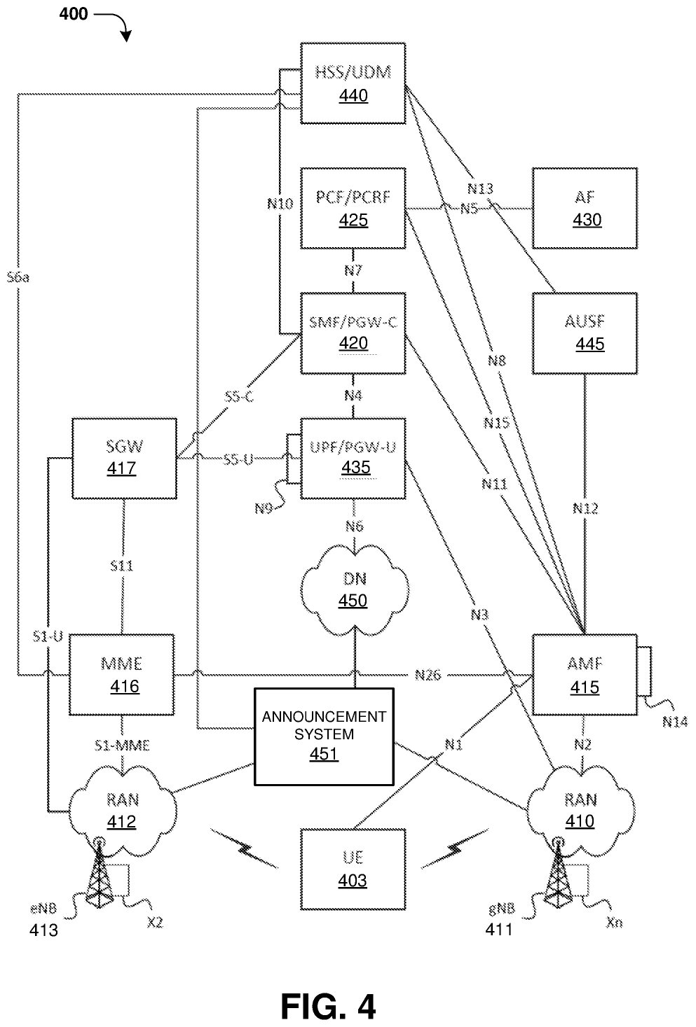

FIG. 4 illustrates an example environment 400, in which one or more embodiments may be implemented. In some embodiments, environment 400 may correspond to a Fifth Generation (“5G”) network, and/or may include elements of a 5G network. In some embodiments, environment 400 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 400 may include UE 403, RAN 410 (which may include one or more Next Generation Node Bs (“gNBs”) 411), RAN 412 (which may include one or more one or more evolved Node Bs (“eNBs”) 413), and various network functions such as Access and Mobility Management Function (“AMF”) 415, Mobility Management Entity (“MME”) 416, Serving Gateway (“SGW”) 417, Session Management Function (“SMF”)/Packet Data Network (“PDN”) Gateway (“PGW”)-Control plane function (“PGW-C”) 420, Policy Control Function (“PCF”)/Policy Charging and Rules Function (“PCRF”) 425, Application Function (“AF”) 430, User Plane Function (“UPF”)/PGW-User plane function (“PGW-U”) 435, Home Subscriber Server (“HSS”)/Unified Data Management (“UDM”) 440, and Authentication Server Function (“AUSF”) 445. Environment 400 may also include one or more networks, such as Data Network (“DN”) 450. Environment 400 may include one or more additional devices or systems communicatively coupled to one or more networks (e.g., DN 450), such as announcement system 451.

The example shown in FIG. 4 illustrates one instance of each network component or function (e.g., one instance of SMF/PGW-C 420, PCF/PCRF 425, UPF/PGW-U 435, HSS/UDM 440, and/or 445). In practice, environment 400 may include multiple instances of such components or functions. For example, in some embodiments, environment 400 may include multiple “slices” of a core network, where each slice includes a discrete set of network functions (e.g., one slice may include a first instance of SMF/PGW-C 420, PCF/PCRF 425, UPF/PGW-U 435, HSS/UDM 440, and/or 445, while another slice may include a second instance of SMF/PGW-C 420, PCF/PCRF 425, UPF/PGW-U 435, HSS/UDM 440, and/or 445). The different slices may provide differentiated levels of service, such as service in accordance with different Quality of Service (“QoS”) parameters.

The quantity of devices and/or networks, illustrated in FIG. 4, is provided for explanatory purposes only. In practice, environment 400 may include additional devices and/or networks, fewer devices and/or networks, different devices and/or networks, or differently arranged devices and/or networks than illustrated in FIG. 4. For example, while not shown, environment 400 may include devices that facilitate or enable communication between various components shown in environment 400, such as routers, modems, gateways, switches, hubs, etc. Alternatively and/or additionally, one or more of the devices of environment 400 may perform one or more network functions described as being performed by another one or more of the devices of environment 400. Devices of environment 400 may interconnect with each other and/or other devices via wired connections, wireless connections, or a combination of wired and wireless connections. In some implementations, one or more devices of environment 400 may be physically integrated in, and/or may be physically attached to, one or more other devices of environment 400.

UE 403 may include a computation and communication device, such as a wireless mobile communication device that is capable of communicating with RAN 410, RAN 412, and/or DN 450. UE 403 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 403 may send traffic to and/or receive traffic (e.g., user plane traffic) from DN 450 via RAN 410, RAN 412, and/or UPF/PGW-U 435.

RAN 410 may be, or may include, a 5G RAN that includes one or more base stations (e.g., one or more gNBs 411), via which UE 403 may communicate with one or more other elements of environment 400. UE 403 may communicate with RAN 410 via an air interface (e.g., as provided by gNB 411). For instance, RAN 410 may receive traffic (e.g., voice call traffic, data traffic, messaging traffic, signaling traffic, etc.) from UE 403 via the air interface, and may communicate the traffic to UPF/PGW-U 435, and/or one or more other devices or networks. Similarly, RAN 410 may receive traffic intended for UE 403 (e.g., from UPF/PGW-U 435, AMF 415, and/or one or more other devices or networks) and may communicate the traffic to UE 403 via the air interface.

RAN 412 may be, or may include, a LTE RAN that includes one or more base stations (e.g., one or more eNBs 413), via which UE 403 may communicate with one or more other elements of environment 400. UE 403 may communicate with RAN 412 via an air interface (e.g., as provided by eNB 413). For instance, RAN 410 may receive traffic (e.g., voice call traffic, data traffic, messaging traffic, signaling traffic, etc.) from UE 403 via the air interface, and may communicate the traffic to UPF/PGW-U 435, and/or one or more other devices or networks. Similarly, RAN 410 may receive traffic intended for UE 403 (e.g., from UPF/PGW-U 435, SGW 417, and/or one or more other devices or networks) and may communicate the traffic to UE 403 via the air interface.

AMF 415 may include one or more devices, systems, Virtualized Network Functions (“VNFs”), etc., that perform operations to register UE 403 with the 5G network, to establish bearer channels associated with a session with UE 403, to hand off UE 403 from the 5G network to another network, to hand off UE 403 from the other network to the 5G network, manage mobility of UE 403 between RANs 410 and/or gNBs 411, and/or to perform other operations. In some embodiments, the 5G network may include multiple AMFs 415, which communicate with each other via the N14 interface (denoted in FIG. 4 by the line marked “N14” originating and terminating at AMF 415).

MME 416 may include one or more devices, systems, VNFs, etc., that perform operations to register UE 403 with the EPC, to establish bearer channels associated with a session with UE 403, to hand off UE 403 from the EPC to another network, to hand off UE 403 from another network to the EPC, manage mobility of UE 403 between RANs 412 and/or eNBs 413, and/or to perform other operations.

SGW 417 may include one or more devices, systems, VNFs, etc., that aggregate traffic received from one or more eNBs 413 and send the aggregated traffic to an external network or device via UPF/PGW-U 435. Additionally, SGW 417 may aggregate traffic received from one or more UPF/PGW-Us 435 and may send the aggregated traffic to one or more eNBs 413. SGW 417 may operate as an anchor for the user plane during inter-eNB handovers and as an anchor for mobility between different telecommunication networks or RANs (e.g., RANs 410 and 412).

SMF/PGW-C 420 may include one or more devices, systems, VNFs, etc., that gather, process, store, and/or provide information in a manner described herein. SMF/PGW-C 420 may, for example, facilitate in the establishment of communication sessions on behalf of UE 403. In some embodiments, the establishment of communications sessions may be performed in accordance with one or more policies provided by PCF/PCRF 425.

PCF/PCRF 425 may include one or more devices, systems, VNFs, etc., that aggregate information to and from the 5G network and/or other sources. PCF/PCRF 425 may receive information regarding policies and/or subscriptions from one or more sources, such as subscriber databases and/or from one or more users (such as, for example, an administrator associated with PCF/PCRF 425).

AF 430 may include one or more devices, systems, VNFs, etc., that receive, store, and/or provide information that may be used in determining parameters (e.g., quality of service parameters, charging parameters, or the like) for certain applications.

UPF/PGW-U 435 may include one or more devices, systems, VNFs, etc., that receive, store, and/or provide data (e.g., user plane data). For example, UPF/PGW-U 435 may receive user plane data (e.g., voice call traffic, data traffic, etc.), destined for UE 403, from DN 450, and may forward the user plane data toward UE 403 (e.g., via RAN 410, SMF/PGW-C 420, and/or one or more other devices). In some embodiments, multiple UPFs 435 may be deployed (e.g., in different geographical locations), and the delivery of content to UE 403 may be coordinated via the N9 interface (e.g., as denoted in FIG. 4 by the line marked “N9” originating and terminating at UPF/PGW-U 435). Similarly, UPF/PGW-U 435 may receive traffic from UE 403 (e.g., via RAN 410, SMF/PGW-C 420, and/or one or more other devices), and may forward the traffic toward DN 450. In some embodiments, UPF/PGW-U 435 may communicate (e.g., via the N4 interface) with SMF/PGW-C 420, regarding user plane data processed by UPF/PGW-U 435.

HSS/UDM 440 and AUSF 445 may include one or more devices, systems, VNFs, etc., that manage, update, and/or store, in one or more memory devices associated with AUSF 445 and/or HSS/UDM 440, profile information associated with a subscriber. AUSF 445 and/or HSS/UDM 440 may perform authentication, authorization, and/or accounting operations associated with the subscriber and/or a communication session with UE 403.

DN 450 may include one or more wired and/or wireless networks. For example, DN 450 may include an Internet Protocol (“IP”)-based PDN, a wide area network (“WAN”) such as the Internet, a private enterprise network, and/or one or more other networks. UE 403 may communicate, through DN 450, with data servers, other UEs UE 403, and/or to other servers or applications that are coupled to DN 450. DN 450 may be connected to one or more other networks, such as a public switched telephone network (“PSTN”), a public land mobile network (“PLMN”), and/or another network. DN 450 may be connected to one or more devices, such as content providers, applications, web servers, and/or other devices, with which UE 403 may communicate.

The announcement system 451 may include one or more devices, systems, VNFs, etc., that perform one, some and/or all operations described herein. For example, the announcement system 451 may at least one of determine a UE location of a UE that requested establishment of a communication session, determine one or more events associated with the location, provide an announcement to the UE based upon the one or more events, etc.

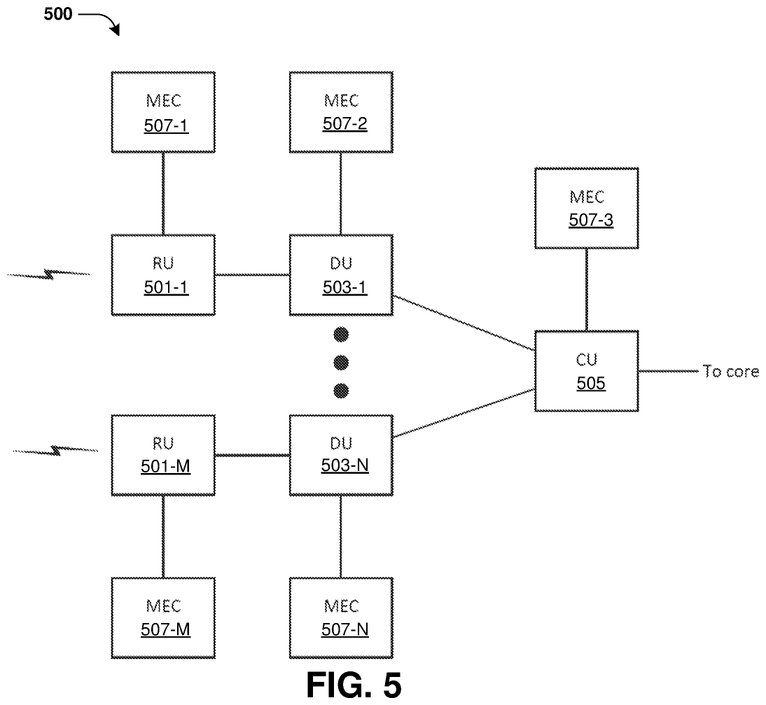

FIG. 5 illustrates an example Distributed Unit (“DU”) network 500, which may be included in and/or implemented by one or more RANs (e.g., RAN 410, RAN 412, or some other RAN). In some embodiments, a particular RAN may include one DU network 500. In some embodiments, a particular RAN may include multiple DU networks 500. In some embodiments, DU network 500 may correspond to a particular gNB 411 of a 5G RAN (e.g., RAN 410). In some embodiments, DU network 500 may correspond to multiple gNBs 411. In some embodiments, DU network 500 may correspond to one or more other types of base stations of one or more other types of RANs. As shown, DU network 500 may include Central Unit (“CU”) 505, one or more Distributed Units (“DUs”) 503-1 through 503-N (referred to individually as “DU 503,” or collectively as “DUs 503”), and one or more Radio Units (“RUs”) 501-1 through 501-M (referred to individually as “RU 501,” or collectively as “RUs 501”).

CU 505 may communicate with a core of a wireless network (e.g., may communicate with one or more of the devices or systems described above with respect to FIG. 4, such as AMF 415 and/or UPF/PGW-U 435). In the uplink direction (e.g., for traffic from UEs UE 403 to a core network), CU 505 may aggregate traffic from DUs 503, and forward the aggregated traffic to the core network. In some embodiments, CU 505 may receive traffic according to a given protocol (e.g., Radio Link Control (“RLC”)) from DUs 503, and may perform higher-layer processing (e.g., may aggregate/process RLC packets and generate Packet Data Convergence Protocol (“PDCP”) packets based upon the RLC packets) on the traffic received from DUs 503.

In accordance with some embodiments, CU 505 may receive downlink traffic (e.g., traffic from the core network) for a particular UE 403, and may determine which DU(s) 503 should receive the downlink traffic. DU 503 may include one or more devices that transmit traffic between a core network (e.g., via CU 505) and UE 403 (e.g., via a respective RU 501). DU 503 may, for example, receive traffic from RU 501 at a first layer (e.g., physical (“PHY”) layer traffic, or lower PHY layer traffic), and may process/aggregate the traffic to a second layer (e.g., upper PHY and/or RLC). DU 503 may receive traffic from CU 505 at the second layer, may process the traffic to the first layer, and provide the processed traffic to a respective RU 501 for transmission to UE 403.

RU 501 may include hardware circuitry (e.g., one or more RF transceivers, antennas, radios, and/or other suitable hardware) to communicate wirelessly (e.g., via an RF interface) with one or more UEs UE 403, one or more other DUs 503 (e.g., via RUs 501 associated with DUs 503), and/or any other suitable type of device. In the uplink direction, RU 501 may receive traffic from UE 403 and/or another DU 503 via the RF interface and may provide the traffic to DU 503. In the downlink direction, RU 501 may receive traffic from DU 503, and may provide the traffic to UE 403 and/or another DU 503.

RUs 501 may, in some embodiments, be communicatively coupled to one or more Multi-Access/Mobile Edge Computing (“MEC”) devices, referred to sometimes herein simply as (“MECs”) 507. For example, RU 501-1 may be communicatively coupled to MEC 507-1, RU 501-M may be communicatively coupled to MEC 507-M, DU 503-1 may be communicatively coupled to MEC 507-2, DU 503-N may be communicatively coupled to MEC 507-N, CU 505 may be communicatively coupled to MEC 507-3, and so on. MECs 507 may include hardware resources (e.g., configurable or provisionable hardware resources) that may be configured to provide services and/or otherwise process traffic to and/or from UE 403, via a respective RU 501.

For example, RU 501-1 may route some traffic, from UE 403, to MEC 507-1 instead of to a core network (e.g., via DU 503 and CU 505). MEC 507-1 may process the traffic, perform one or more computations based upon the received traffic, and may provide traffic to UE 403 via RU 501-1. In this manner, ultra-low latency services may be provided to UE 403, as traffic does not need to traverse DU 503, CU 505, and an intervening backhaul network between DU network 500 and the core network. In some embodiments, MEC 507 may include, and/or may implement some or all of the functionality described above with respect to at least one of the announcement system 451, the announcement system 112, the system 101, the method 200, the system 301, etc.

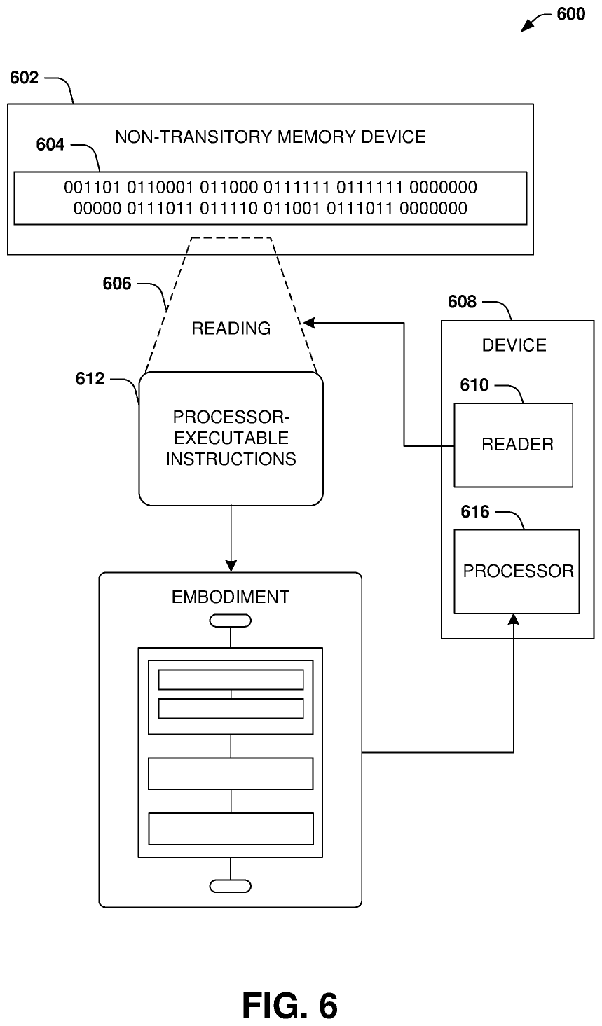

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 101 of FIGS. 1A-1l and/or the example system 301 of FIG. 3, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed is:

1. A method, comprising:
receiving, from a first user equipment (UE), a request to establish a communication session with a second UE;
determining, based upon the request, a location of the first UE;
analyzing an event datastore, based upon the location of the first UE, to identify one or more events potentially impacting telecommunication services provided to the first UE; and
providing, based upon the one or more events, an announcement for presentation on the first UE.

2. The method of claim 1, wherein determining the location of the first UE comprises:
analyzing the request to identify a UE identifier, of the first UE, in the request;
analyzing a location datastore to identify location information associated with the UE identifier; and
determining the location based upon the location information.

3. The method of claim 1, wherein determining the location of the first UE comprises:
analyzing the request to identify a geolocation field in the request; and
determining the location based upon a location object in the geolocation field.

4. The method of claim 3, wherein:
the location object comprises a set of geographical coordinates indicative of a geographical position of the first UE; and
the location corresponds to a geographical region comprising the geographical position.

5. The method of claim 1, wherein determining the location of the first UE comprises:
analyzing the request to identify a reference to a resource comprising a location object associated with the first UE;
accessing, based upon the reference, the resource; and
determining the location based upon the location object in the resource.

6. The method of claim 1, wherein:
the communication session corresponds to at least one of a voice call or a video call;
the announcement comprises audio comprising speech representative of the one or more events; and
providing the announcement for presentation on the first UE comprises transmitting the audio to the first UE.

7. The method of claim 1, comprising:
after providing the announcement for presentation on the first UE, attempting to establish the communication session.

8. The method of claim 1, comprising:
prior to providing the announcement for presentation on the first UE, attempting to establish the communication session.

9. The method of claim 8, wherein:
providing the announcement for presentation on the first UE is performed in response to a determination that the attempt to establish the communication session is unsuccessful.

10. The method of claim 1, wherein providing the announcement for presentation on the first UE comprises:
generating a message indicative of an event of the one or more events;
synthesizing audio comprising speech representative of the message; and
transmitting the audio to the first UE.

11. The method of claim 1, wherein providing the announcement for presentation on the first UE comprises:
analyzing an announcement datastore comprising announcements associated with a plurality of event types; and
selecting the announcement from the announcement datastore based upon a determination that an event type associated with the announcement matches an event of the one or more events.

12. The method of claim 1, wherein an event location is stored in the event datastore in association with an event, the method comprising:
comparing the location of the first UE to event locations in the event datastore; and
in response to determining that the event location corresponds to the location of the first UE, identifying the event associated with the event location as one of the one or more events.

13. The method of claim 1, comprising:
identifying a message transmitted by a network element associated with a network element event associated with at least one of maintenance of the network element or failure of the network element;
analyzing the message to identify a geolocation field in the message;
determining a network element location based upon the geolocation field;
storing the network element location, in association with the network element event, in the event datastore;
comparing the location of the first UE to network element locations in the event datastore; and
in response to determining that the network element location corresponds to the location of the first UE, identifying the network element event associated with the network element location as one of the one or more events.

14. A non-transitory computer-readable medium storing instructions that when executed perform operations comprising:
receiving, from a first user equipment (UE), a request to establish a communication session with a second UE;
in response to the request, analyzing a location datastore to identify location information associated with the first UE;
determining a location of the first UE based upon the location information;
analyzing an event datastore, based upon the location of the first UE, to identify one or more events potentially impacting telecommunication services provided to the first UE; and
providing, based upon the one or more events, an announcement for presentation on the first UE.

15. The non-transitory computer-readable medium of claim 14, the operations comprising:
analyzing the request to identify a UE identifier, of the first UE, in the request, wherein the location information is used to determine the location of the first UE based upon the location information comprising an indication of the UE identifier.

16. The non-transitory computer-readable medium of claim 14, wherein:
the communication session corresponds to at least one of a voice call or a video call;
the announcement comprises audio comprising speech representative of the one or more events; and
providing the announcement for presentation on the first UE comprises transmitting the audio to the first UE.

17. The non-transitory computer-readable medium of claim 14, the operations comprising:
after providing the announcement for presentation on the first UE, attempting to establish the communication session.

18. The non-transitory computer-readable medium of claim 17, wherein:
providing the announcement for presentation on the first UE is performed in response to a determination that the attempt to establish the communication session is unsuccessful.

19. A system comprising a processor configured to:
receive, from a first user equipment (UE), a request to establish a communication session with a second UE;
determine, in response to the request, at least one of a first location of the first UE or a second location of the second UE;
analyze an event datastore, based upon at least one of the first location or the second location, to identify one or more events potentially impacting telecommunication services provided to at least one of the first UE or the second UE; and
provide, based upon the one or more events, an announcement for presentation on the first UE.

20. The system of claim 19, wherein:
the communication session corresponds to at least one of a voice call or a video call; and
the announcement comprises audio comprising speech representative of the one or more events.
